(19) United States
(12) Patent Application Publication
(10) Pub. No.: US 2026/0081077 A1
(43) Pub. Date: Mar. 19, 2026

(54) MULTILAYER CERAMIC CAPACITOR

(71) Applicant: SAMSUNG ELECTRO-MECHANICS CO., LTD., Suwon-si (KR)

(72) Inventors: Euihyun Jo, Suwon-si (KR); Hongseok Kim, Suwon-si (KR); Hojun Lee, Suwon-si (KR); Jimin Youn, Suwon-si (KR); Jin Sung Kim, Suwon-si (KR)

(73) Assignee: SAMSUNG ELECTRO-MECHANICS CO., LTD., Suwon-si (KR)

(21) Appl. No.: 19/051,740

(22) Filed: Feb. 12, 2025

(30) Foreign Application Priority Data
Sep. 19, 2024 (KR) 10-2024-0126684
Nov. 25, 2024 (KR) 10-2024-0170037

(51) Int. Cl. H01G 4/232; H01G 4/008; H01G 4/012; H01G 4/12; H01G 4/30

(52) U.S. Cl. CPC H01G 4/2325; H01G 4/008; H01G 4/012; H01G 4/12; H01G 4/30

(57) ABSTRACT

A multilayer ceramic capacitor may include a ceramic body, and an external electrode disposed outside the ceramic body. The ceramic body may include first and second surfaces facing each other in a first direction, third and fourth surfaces facing each other in a second direction and connecting the first surface and the second surface, fifth and sixth surfaces facing each other in a third direction and connecting the first surface and the second surface. The external electrode may include a metal electrode layer on the first and second surfaces, a sintered electrode layer on the metal electrode layer, and a conductive resin layer on a portion of at least one surface among the third to sixth surfaces. The conductive resin layer may contact the sintered electrode layer in a portion connecting the first and second surfaces to at least one surface among the third to sixth surfaces.

### CROSS-REFERENCE TO RELATED APPLICATION

This application claims priority to and the benefit of Korean Patent Application Nos. 10-2024-0126684 filed on Sep. 19, 2024, and 10-2024-0170037 filed on Nov. 25, 2024, in the Korean Intellectual Property Office, the entire disclosures of which are incorporated herein by reference for all purposes.

### BACKGROUND

### (a) Technical Field

The present disclosure relates to a multilayer ceramic capacitor.

### (b) Description of the Related Art

As electronic components using a ceramic material, there are a capacitor, an inductor, a piezoelectric element, a varistor, a thermistor, and the like. Among these ceramic electronic components, a multilayer ceramic capacitors (MLCC) may be used in various electronic devices due to their small size, high capacitance, and ease of mounting.

A multilayer ceramic capacitor is an electronic device in the form of a chip that is mounted on a substrate of various electronic products, such as an image device such as liquid crystal display (LCD), plasma display panel (PDP), an organic light emitting diode (OLED), a computer, a personal portable terminal and a smart phone, to charge and discharge electricity.

As the usage environments of multilayer ceramic capacitors diversify, the bending characteristics and impact resistance of multilayer ceramic capacitors are considered important.

The multilayer ceramic capacitor may include internal electrodes disposed inside the ceramic body and external electrodes disposed outside the ceramic body and connected to the internal electrodes. At this time, a chip with a soft external electrode structure and improved electrode connectivity is required. A decrease in the electrical connectivity of multilayer ceramic capacitors can cause an increase in the equivalent series resistance (ESR).

### SUMMARY

The present disclosure attempts to provide a multilayer ceramic capacitor having low bending crack frequency, impact resistance, and improved electrode connectivity.

However, the problem to be solved by the embodiments of the present disclosure is not limited to the above-described problems, and can be variously extended within the scope of the technical spirit included in the present disclosure.

A multilayer ceramic capacitor may include a ceramic body including a plurality of dielectric layers, and a plurality of internal electrodes disposed such that at least one internal electrode among the plurality of internal electrodes interpose the plurality of dielectric layers, and an external electrode disposed outside the ceramic body, where the ceramic body may include a first surface and a second surface facing each other in a first direction, a third surface and a fourth surface facing each other in a second direction and connecting the first surface and the second surface, a fifth surface and a sixth surface facing each other in a third direction and connecting the first surface and the second surface, where the external electrode may include a metal electrode layer disposed on the first surface and the second surface of the ceramic body, the metal electrode layer connecting to the internal electrode, a sintered electrode layer disposed on the metal electrode layer, the sintered electrode layer including metal and glass, and a conductive resin layer disposed on a portion of at least one surface among the third surface to the sixth surface of the ceramic body, where the conductive resin layer may be in contact with the sintered electrode layer in a portion connecting the first surface and the second surface of the ceramic body to at least one surface among the third surface to the sixth surface.

At least one end portion of the sintered electrode layer may be disposed in the portion connecting the first surface and the second surface of the ceramic body to at least one surface among the third surface to the sixth surface.

At least one end portion of the sintered electrode layer may be disposed onto a portion of at least one surface among the third surface to the sixth surface of the ceramic body.

A first end of the conductive resin layer may be in contact with the at least one end portion of the sintered electrode layer.

A first end of the conductive resin layer may cover the at least one end portion of the sintered electrode layer.

The conductive resin layer may not be disposed on an outer surface disposed in the first direction among outer surfaces of the sintered electrode layer.

The sintered electrode layer may cover the metal electrode layer.

The sintered electrode layer may have a thickness decreasing toward an end portion of the sintered electrode layer.

The conductive resin layer may include a first end portion in contact with the sintered electrode layer, and a second end portion facing the first end portion in the first direction.

The first end portion of the conductive resin layer may cover at least one end portion of the sintered electrode layer.

The metal electrode layer may include copper (Cu) or nickel (Ni).

The metal electrode layer may have a thickness of 0.5 μm or more and 3 μm or less in the first direction.

The conductive resin layer may include a conductive metal and epoxy.

The multilayer ceramic capacitor may further include a plating layer covering the external electrode.

A multilayer ceramic capacitor may include a ceramic body including a plurality of dielectric layers, and a plurality of internal electrodes disposed such that at least one internal electrode among the plurality of internal electrodes interpose the plurality of dielectric layers, an external electrode disposed outside the ceramic body, where the ceramic body may include a first surface and a second surface facing each other in a first direction, a third surface and a fourth surface facing each other in a second direction and connecting the first surface and the second surface, and a fifth surface and a sixth surface facing each other in a third direction and connecting the first surface and the second surface, where the external electrode may include a metal electrode layer disposed on the first surface and the second surface of the ceramic body, the metal electrode layer connecting to the internal electrode, a sintered electrode layer disposed on the metal electrode layer, the sintered electrode layer including metal and glass, and a conductive resin layer disposed on a portion of at least one surface among the third surface to the sixth surface of the ceramic body, the conductive resin layer connecting to the sintered electrode layer, where the conductive resin layer may not be disposed on an outer surface disposed in the first direction among outer surfaces of the sintered electrode layer.

The conductive resin layer may include a first end portion in contact with the sintered electrode layer, and a second end portion facing the first end portion in the first direction.

The first end portion of the conductive resin layer may cover at least one end portion of the sintered electrode layer.

A multilayer ceramic capacitor may include a ceramic body including a plurality of dielectric layers, and a plurality of internal electrodes disposed such that at least one internal electrode among the plurality of internal electrodes interpose the plurality of dielectric layers, and an external electrode disposed outside the ceramic body, the external electrode may include a first electrode layer disposed on opposing surfaces of the ceramic body, the first electrode layer may connect to the plurality of internal electrodes, and the first electrode layer may include a metal, a second electrode layer including a first portion disposed on the first electrode layer, and a second portion disposed on corners of the ceramic body, the second electrode layer may include metal and glass, and a conductive resin layer disposed the corners of the ceramic body such that, along a stacking direction of the plurality of internal electrodes, the conductive resin layer may overlap the second portion of the second electrode layer and not the first portion of the electrode layer.

The first electrode layer may be free of glass.

The second electrode layer may cover the first electrode layer.

The second electrode layer may have a thickness decreasing toward an end portion of the second electrode layer.

According to a multilayer ceramic capacitor according to the embodiment, the frequency of crack occurrence due to bending is low, impact resistance is provided, and the electrode connectivity is improved, so that the equivalent series resistance (ESR) may be reduced.

However, it is obvious that the effect of the embodiments is not limited to the above-described effect, and may be variously extended without departing from the spirit and scope of the embodiments.

### BRIEF DESCRIPTION OF THE DRAWINGS

FIG. 1 is a perspective view schematically showing a multilayer ceramic capacitor according to an embodiment.

FIG. 2 is a cross-sectional view taken along line II-II′ of FIG. 1.

FIG. 3 is an enlarged view of portion A of FIG. 2.

FIG. 4 is an exploded perspective view showing a stacking structure of an internal electrode in the multilayer ceramic capacitor of FIG. 1.

FIG. 5 is a digital image with respect to a portion of a multilayer ceramic capacitor according to an embodiment.

FIG. 6 is a cross-sectional view in the L-T direction of a multilayer ceramic capacitor according to another embodiment.

FIG. 7 is a digital image with respect to a portion of a multilayer ceramic capacitor according to another embodiment.

FIG. 8 is a drawing for explaining a bending test method of a multilayer ceramic capacitor.

### DETAILED DESCRIPTION

Hereinafter, various embodiment of the present disclosure will be described in detail so that a person of ordinary skill in the technical field to which the present disclosure belongs can easily implement it with reference to the accompanying drawings. The drawings and description are to be regarded as illustrative in nature and not restrictive. Like reference numerals designate like elements throughout the specification. In addition, some components in the drawings may be exaggerated, omitted, or schematically illustrated, and the size of each component may not entirely reflect the actual size.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various components, and are not to be interpreted as limiting these components. The terms are only used to differentiate one component from other components.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

It will be further understood that terms “comprises/includes” or “have” used throughout the specification specify the presence of stated features, numerals, steps, operations, components, parts, or a combination thereof, but do not preclude the presence or addition of one or more other features, numerals, steps, operations, components, parts, or a combination thereof. Accordingly, unless explicitly described to the contrary, the word “comprise” and variations such as “comprises” or “comprising” will be understood to imply the inclusion of stated components but not the exclusion of any other components.

Further, throughout the specification, the phrase “in a plan view” means when an object portion is viewed from above, and the phrase “in a cross-sectional view” means when a cross-section taken by vertically cutting an object portion is viewed from the side.

In addition, throughout the specification, “connected” means that two or more components are not only directly connected, but two or more components may be connected indirectly through other components, physically connected as well as being electrically connected, or it may be referred to by different names depending on the location or function, but may mean integral.

The external electrode may include a metal electrode layer (e.g., a first electrode layer), a sintered electrode layer (e.g., a second electrode layer), and a conductive resin layer.

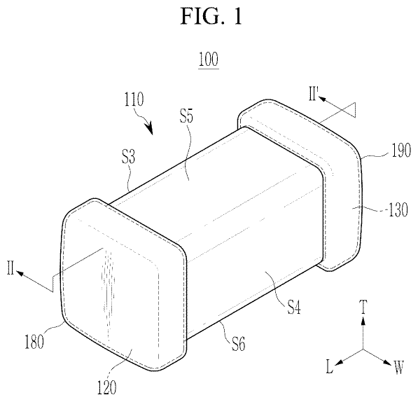

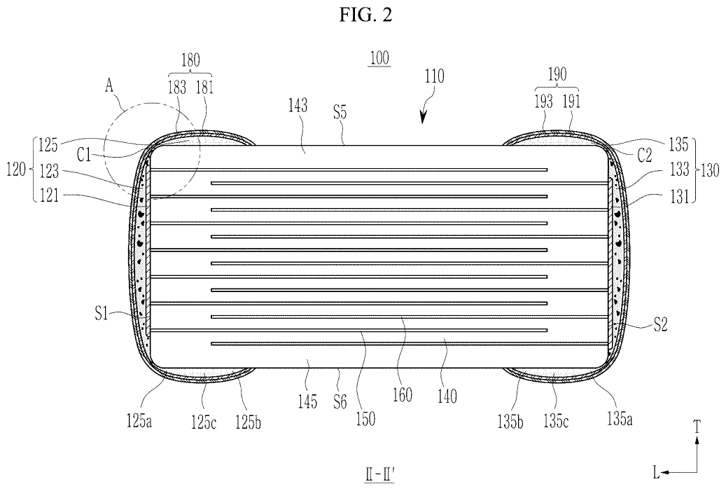

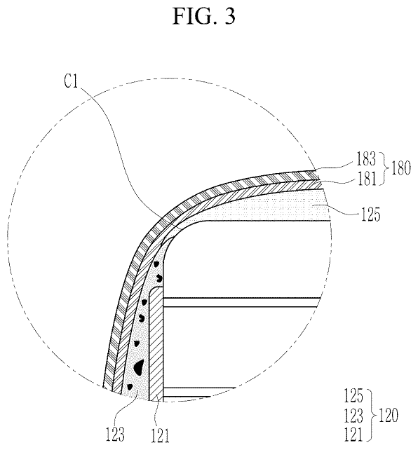

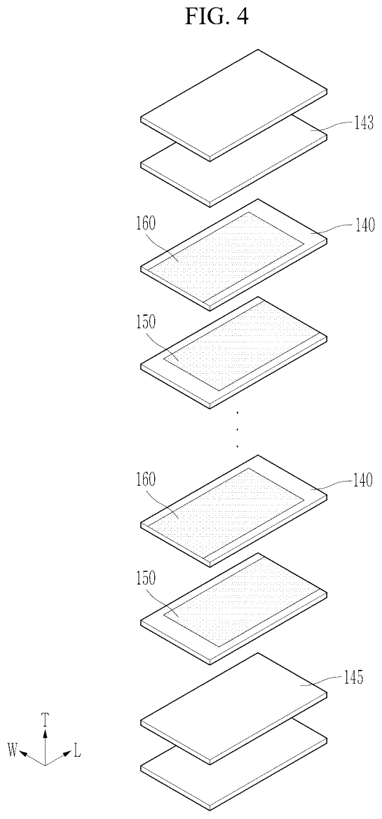

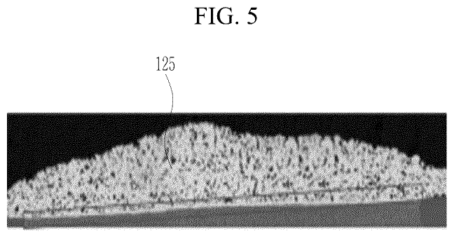

FIG. 1 is a perspective view schematically showing a multilayer ceramic capacitor according to an embodiment, FIG. 2 is a cross-sectional view taken along line II-II′ of FIG. 1, FIG. 3 is an enlarged view of portion A of FIG. 2, FIG. 4 is an exploded perspective view showing a stacking structure of an internal electrode in the multilayer ceramic capacitor of FIG. 1, and FIG. 5 is a digital image with respect to a portion of the multilayer ceramic capacitor according to an embodiment.

Referring to FIG. 1 to FIG. 3, a multilayer ceramic capacitor 100 according to the present embodiment includes a ceramic body 110, a first external electrode 120, a second external electrode 130, a plurality of first internal electrodes 150 and a plurality of second internal electrodes 160.

First, for directions defined for describing the present embodiment, L-axis, W-axis, and T-axis shown in the drawings indicates axes indicating a length direction, a width direction, and a thickness direction of the multilayer ceramic capacitor 100, respectively.

The thickness direction (T-axis direction) may be a direction perpendicular to a wide surface (major surface) of sheet-like constituent elements. For example, the thickness direction (T-axis direction) may be used as the same concept as the direction in which dielectric layers 140 are stacked.

The length direction (L-axis direction) is a direction parallel to the wide surfaces (main surfaces) of the sheet-like components, and may be a direction that intersects (or is orthogonal to) the thickness direction (T-axis direction). For example, the length direction (L-axis direction) may be a direction in which the first external electrode 120 and the second external electrode 130 face each other.

The width direction (W-axis direction) is a direction parallel to the wide surface (main surface) of the sheet-like components, and may be a direction that simultaneously intersects (or crosses) the thickness direction (T-axis direction) and the length direction (L-axis direction).

The ceramic body 110 may have a substantially hexahedral shape, but the present embodiment is not limited thereto. Due to contraction during sintering, the ceramic body 110 may have a substantially hexahedral shape, although not a perfect hexahedral shape. For example, the ceramic body 110 has a substantially rectangular hexahedral shape, but corner or vertex portions may have a rounded shape.

In the present embodiment, for convenience of description, surfaces facing each other in the length direction (L-axis direction) may be defined as length directional end surfaces or as a first surface S1 and a second surface S2, surfaces facing each other in the width direction (W-axis direction) and connecting the first surface S1 and the second surface S2 may be defined as width directional end surfaces or as a third surface S3 and a fourth surface S4, and surfaces facing each other in the thickness direction (T-axis direction) and connecting the first surface S1 and the second surface S2 may be defined as thickness directional end surfaces or as a fifth surface S5 and a sixth surface S6.

Therefore, a first direction, which is a direction in which the first surface S1 and the second surface S2 face each other, may be the length direction (L-axis direction), and a second direction and a third direction that are perpendicular to the first direction and perpendicular to each other may be the thickness direction (T-axis direction) and the width direction (W-axis direction), respectively, or the width direction (W-axis direction) and the thickness direction (T-axis direction), respectively. According to this, the ceramic body 110 may include the first surface S1 and the second surface S2 facing in the first direction, the third surface S3 and the fourth surface S4 facing in the second direction and connecting the first surface S1 and the second surface S2, and the fifth surface S5 and the sixth surface S6 facing in the third direction and connecting the first surface S1 and the second surface S2.

In addition, an area between a length directional end surface and a thickness directional or width directional end surface of the ceramic body 110 is defined as an edge portion. That is, the edge portion may include a curved surface portion connecting the third surface S3 to the sixth surface S6 and the first surface S1, which may be referred to as a first edge portion C1, and a curved surface portion connecting the third surface S3 to the sixth surface S6 and the second surface S2, which is referred to as a second edge portion C2.

A length of the ceramic body 110 may mean, based on an optical microscope or scanning electron microscope (SEM) photograph of a cross-section in the length direction (L-axis direction)-the thickness direction (T-axis direction) at a center of the width direction (W-axis direction) of the ceramic body 110, a maximum value of lengths of a plurality of line segments that connect two outermost boundary lines facing each other in the length direction (L-axis direction) of the ceramic body 110 shown in the above cross-sectional photograph and are parallel to the length direction (L-axis direction). Meanwhile, the length of the ceramic body 110 may mean a minimum value of lengths of a plurality of line segments that connect two outermost boundary lines facing each other in the length direction (L-axis direction) of the ceramic body 110 shown in the above-mentioned cross-section photograph and are parallel to the length direction (L-axis direction), respectively. Alternatively, the length of the ceramic body 110 may mean an arithmetic average value of lengths of at least two of a plurality of line segments that connect two outermost boundary lines facing each other in the length direction (L-axis direction) of the ceramic body 110 shown in the above cross-sectional photograph and are parallel to the length direction (L-axis direction).

A thickness of the ceramic body 110 may mean, based on an optical microscope or scanning electron microscope (SEM) photograph of a cross-section in the length direction (L-axis direction)-the thickness direction (T-axis direction) at a center of the width direction (W-axis direction) of the ceramic body 110, a maximum value of lengths of a plurality of line segments that connect two outermost boundary lines facing each other in the thickness direction (T-axis direction) of the ceramic body 110 shown in the above cross-sectional photograph and are parallel to the thickness direction (T-axis direction). Meanwhile, the thickness of the ceramic body 110 may mean a minimum value of lengths of a plurality of line segments that connect two outermost boundary lines facing each other in the thickness direction (T-axis direction) of the ceramic body 110 shown in the above-mentioned cross-section photograph and are parallel to the thickness direction (T-axis direction), respectively. On the other hand, the thickness of the ceramic body 110 may mean an arithmetic average value of lengths of at least two line segments among a plurality of line segments that connect two outermost boundary lines facing each other in the thickness direction (T-axis direction) of the ceramic body 110 shown in the above-mentioned cross-section photograph and parallel to the thickness direction (T-axis direction), respectively.

A width of the ceramic body 110 may mean, based on an optical microscope or scanning electron microscope (SEM) photograph of a cross-section in the length direction (L-axis direction)-the width direction (W-axis direction) at a center of the thickness direction (T-axis direction) of the ceramic body 110, a maximum value of lengths of a plurality of line segments that connect two outermost boundary lines facing each other in the width direction (W-axis direction) of the ceramic body 110 shown in the above cross-sectional photograph and are parallel to the width direction (W-axis direction). Meanwhile, the width of the ceramic body 110 may mean a minimum value of lengths a plurality of line segments that connect two outermost boundary lines facing each other in the width direction (W-axis direction) of the ceramic body 110 shown in the above-mentioned cross-section photograph and are parallel to the width direction (W-axis direction), respectively. On the other hand, the width of the ceramic body 110 may mean an arithmetic average value of lengths of at least two line segments among a plurality of line segments that connect two outermost boundary lines facing each other in the width direction (W-axis direction) of the ceramic body 110 shown in the above-mentioned cross-section photograph and are parallel to the width direction (W-axis direction), respectively.

The ceramic body 110 may include a plurality of dielectric layers 140 stacked in the thickness direction (T-axis direction). A boundary between the dielectric layers 140 may be unclear. For example, boundaries between the dielectric layers 140 are difficult to see without using a scanning electron microscope (SEM), and multiple dielectric layers 140 may appear as a single structure.

The first internal electrode 150 and the second internal electrode 160 may be alternately stacked interposing the dielectric layer 140. This stacked structure may be repeated within the ceramic body 110, the internal electrode closest to the fifth surface S5 of the ceramic body 110 may be the first internal electrode 150 or the second internal electrode 160 and the internal electrode closest to the sixth surface S6 may be the first internal electrode 150 or the second internal electrode 160.

The first internal electrode 150 and the second internal electrode 160 have different polarities, and may be electrically insulated from each other by the dielectric layer 140 disposed therebetween.

The first internal electrode 150 and the second internal electrode 160 may be disposed to be offset from each other in the length direction (L-axis direction) interposing the dielectric layer 140. A first side end portion of the first internal electrode 150 may be exposed through the first surface S1 of the ceramic body 110, and a first side end portion of the second internal electrode 160 may be exposed through the second surface S2 of the ceramic body 110. The end portion of the first internal electrode 150 exposed from the first surface S1 of the ceramic body 110 may be connected to the first external electrode 120. The end portion of the second internal electrode 160 exposed from the second surface S2 of the ceramic body 110 may be connected to the second external electrode 130.

The first internal electrode 150 and the second internal electrode 160 may be formed by printing a conductive paste containing a conductive metal on a surface of the dielectric layer 140. For example, internal electrodes may be formed by printing a conductive paste containing nickel (Ni) or a nickel (Ni) alloy on the surface of the dielectric layer by screen printing or gravure printing. However, the present embodiment is not limited thereto.

For example, an average thickness of the first internal electrode 150 and the second internal electrode 160 may be generally 0.1 μm or more and 2 μm or less.

Here, the thickness of the internal electrode may mean an average thickness of one internal electrode disposed between two dielectric layers may mean. Based on scanning electron microscope (SEM) photograph of magnification of 10,000 times with respect to the length direction (L-axis direction)-the thickness direction (T-axis direction) cross-section at the central portion of the ceramic body 110 in the width direction (W-axis direction), the average thickness of the internal electrode may be an arithmetic average value of values obtained by measuring thicknesses of one internal electrode shown in above-mentioned cross-sectional photograph at 30 points having uniform interval in the length direction (L-axis direction). The above-mentioned 30 points may be designated in an active region described later. By measuring the average thickness of each of the 10 internal electrodes in this way and then deriving the arithmetic average of the measured values, the average thickness of the internal electrodes may be further generalized.

When a voltage is applied to the first external electrode 120 and the second external electrode 130, charges are accumulated between the first internal electrode 150 and the second internal electrode 160 that face each other. That is, a capacitance may be obtained between the first internal electrode 150 electrically connected to the first external electrode 120 and the second internal electrode 160 electrically connected to the second external electrode 130. A capacitance of the multilayer ceramic capacitor 100 is proportional to an overlapping area of the first internal electrode 150 and the second internal electrode 160 overlapping each other along the thickness direction (T-axis direction).

In other words, the multilayer ceramic capacitor 100 may include an active region and a margin region. The active region may refer to a region where the first internal electrode 150 and the second internal electrode 160 overlap along the thickness direction (T-axis direction), and the margin region may refer to a region between the first surface S1 of the ceramic body 110 and the active region and a region between the second surface S2 of the ceramic body 110 and the active region.

The multilayer ceramic capacitor 100 is classified based on its length and width. Therefore, even in multilayer ceramic capacitors having the same length or width, the size of the ceramic body may vary according to the thickness of the external electrode. That is, a multilayer ceramic capacitor having a thinner external electrode may have a larger ceramic body than a multilayer ceramic capacitor having a thicker external electrode. If the ceramic body is larger, it may mean that the above-described active area is larger, and furthermore, capacitance may be larger. As a result, capacitance may increase as the external electrode of the multilayer ceramic capacitor becomes thinner. In this embodiment, by forming a thin electrode layer on the first and second surfaces of the ceramic body, the thickness of the external electrode can be reduced, and a beneficial effect can be obtained accordingly. This will be explained in more detail below.

A first cover layer 143 and a second cover layer 145 may be disposed outside of the active region in the thickness direction (T-axis direction).

The first cover layer 143 is disposed between the fifth surface S5 of the ceramic body 110 and the internal electrode closest thereto. The second cover layer 145 is disposed between the sixth surface S6 of the ceramic body 110 and the internal electrode closest thereto.

That is, in the ceramic body 110, the first cover layer 143 may be disposed above an uppermost internal electrode, and the second cover layer 145 may be disposed below a lowermost internal electrode. The first cover layer 143 and the second cover layer 145 may have the same composition as the dielectric layer 140. The first cover layer 143 and the second cover layer 145 may be formed by stacking one or more dielectric layers on each of an outer surface of an uppermost internal electrode and an outer surface of a lowermost internal electrode.

The first cover layer 143 and the second cover layer 145 may serve to prevent damage to the first internal electrode 150 and the second internal electrode 160 due to physical or chemical stress.

The dielectric layer 140 may include a ceramic material having a high permittivity. For example, ceramic material may include a dielectric ceramic including components such as BaTiO₃, CaTiO₃, SrTiO₃, or CaZrO₃. In addition, an auxiliary component, such as a manganese (Mn) compound, an iron (Fe) compound, a chromium (Cr) compound, a cobalt (Co) compound, and a nickel (Ni) compound may be further included to these components. For example, examples of the dielectric layer may be (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, or the like, in which calcium (Ca), zirconium (Zr), or the like is partially dissolved in BaTiO₃, the present disclosure is not limited thereto.

In addition, at least one of a ceramic additive, an organic solvent, a plasticizer, a binder, and a dispersant may be further included in the dielectric layer 140. The ceramic additive may be, for example, a transition metal oxide or carbide, a rare earth element, magnesium (Mg), aluminum (Al), and the like.

For example, the average thickness of the dielectric layer 140 may be 0.1 μm to 10 μm, but the present embodiment is not limited thereto.

The first external electrode 120 and the second external electrode 130 are disposed outside the ceramic body 110.

The first external electrode 120 may be disposed on the first surface S1 of the ceramic body 110, and may extend to a portion of at least one surface of the third surface S3, the fourth surface S4, the fifth surface S5, and the sixth surface S6. The second external electrode 130 may be disposed on the second surface S2 of the ceramic body 110, and may extend to a portion of at least one surface of the third surface S3, the fourth surface S4, the fifth surface S5, and the sixth surface S6.

The first external electrode 120 may include a first metal electrode layer 121 (e.g., a first electrode layer), a first sintered electrode layer 123 (e.g., a second electrode layer), and a first conductive resin layer 125.

The first metal electrode layer 121 may be disposed on the first surface S1 of the ceramic body 110, and may be a portion electrically connected to exposed end portions of the plurality of first internal electrodes 150.

The first metal electrode layer 121 may be a layer including a conductive metal (e.g., copper (Cu) or nickel (Ni)), and preferably having a metal containing ratio per unit volume of 99% by volume or more, and preferably not containing glass.

The first metal electrode layer 121 may be formed by metal-organic decomposition (MOD), sputtering, plating, or the like, and a thickness of the first metal electrode layer 121 is not particularly limited, but is preferably 0.5 μm or more and 3 μm or less. This is a range for minimizing the thickness of the first external electrode 120 while securing electrical connection between the first internal electrode 150 and the first external electrode 120. Here, the thickness of the first metal electrode layer 121 refers to the thickness in the first direction (longitudinal direction) of the ceramic body 110. The thickness of the metal electrode layer may be observed by a scanning electron microscope (SEM). Other methods and/or tools appreciated by one of ordinary skill in the art, even if not described in the present disclosure, may also be used.

Unlike the present embodiment, when only a sintered electrode layer is disposed on the first surface S1 of the ceramic body 110 without a metal electrode layer, since a sintered electrode layer has a lower electrical connectivity than a metal electrode layer, a problem of increasing equivalent series resistance (ESR) of the first external electrode may occur.

On the other hand, according to the present embodiment, by forming a metal electrode layer of a thin film in the interface between the internal electrode and the external electrode, the electrical connectivity between the internal electrode and the external electrode may be improved while minimizing the thickness of the external electrode, and accordingly, equivalent series resistance (ESR) characteristics may be improved.

Meanwhile, the first metal electrode layer 121, which is a layer for electrical connection to the internal electrode, may be disposed on the first surface S1 of the ceramic body 110, and may be disposed to cover the exposed end portions of the plurality of first internal electrodes 150 on the first surface S1 of the ceramic body 110.

The first sintered electrode layer 123 may be disposed on the first metal electrode layer 121, and may include metal and glass. Here, the metal may include a conductive metal such as copper (Cu) or nickel (Ni), and the glass may include B—Si-based glass, B—Si—Zn-based glass, B—Si—Zn—Ba-based glass, B—Si—Zn—Ba—Ca—Al-based glass, or the like.

The first sintered electrode layer 123 may be formed by applying and drying a paste including metal and glass on the first metal electrode layer 121, and then heat-treating it. Accordingly, the first sintered electrode layer 123 may completely cover the first metal electrode layer 121. In this way, hermetic sealing of the external electrode can be secured. In addition, the first sintered electrode layer 123 may have a thickness decreasing toward an end portion. The decreasing thickness may be observed by an optical microscope or a scanning electron microscope (SEM). Other methods and/or tools appreciated by one of ordinary skill in the art, even if not described in the present disclosure, may also be used.

An end portion of the first sintered electrode layer 123 may be in contact with an end portion of the first metal electrode layer 121. In addition, the end portion of the first sintered electrode layer 123 may cover the end portion of the first metal electrode layer 121. To this end, the end portion of the first sintered electrode layer 123 may be disposed at a portion connecting at least one surface of the third surface S3, the fourth surface S4, the fifth surface S5, and the sixth surface S6, which are the thickness directional or width directional end surfaces of the ceramic body 110, and the first surface S1, which is the length directional end surface of the ceramic body 110. Hereinafter, for better comprehension and ease of description, the portion connecting the first surface S1 and at least one surface among the third surface S3, the fourth surface S4, the fifth surface S5, and the sixth surface S6 of the ceramic body 110 is referred to as the first edge portion C1.

The first conductive resin layer 125 may be disposed on at least one surface of the third surface S3, the fourth surface S4, the fifth surface S5, and the sixth surface S6 which are the thickness directional or width directional end surface of the ceramic body 110, and may be formed of a conductive and stretchable material. For example, the first conductive resin layer 125 may include a conductive metal or an intermetallic compound, and may include various polymer materials having a low elastic modulus.

The resin included in the first conductive resin layer 125 may be various known thermosetting resins such as, for example, epoxy resin, phenol resin, urethane resin, silicone resin, polyimide resin, or the like. Among them, it may be preferable to use an epoxy resin, which has excellent heat resistance, moisture resistance, and adhesion.

Meanwhile, the first conductive resin layer 125 is a filler, and may include a conductive metal. For example, the filler may include copper (Cu), silver (Ag), nickel (Ni), tin (Sn) or alloys thereof.

The first conductive resin layer 125 may be in contact with the first sintered electrode layer 123 in the first edge portion C1. That is, a first end of the first conductive resin layer 125 may be in contact with the end portion of the first sintered electrode layer 123. Preferably, the first end of the first conductive resin layer 125 may cover the end portion of the first sintered electrode layer 123.

In more detail, the first conductive resin layer 125 may include a first end portion 125a in contact with the first sintered electrode layer 123, a second end portion 125b facing the first end portion 125a in the length direction (L-axis direction) of the ceramic body 110, and a first central portion 125c disposed between the first end portion 125a and the second end portion 125b. The first end portion 125a may be in contact with the end portion of the first sintered electrode layer 123, and may preferably cover the end portion of the first sintered electrode layer 123.

Referring to FIG. 5, the first conductive resin layer 125 may have a thickness decreasing toward both end portions. That is, the first conductive resin layer 125 may have a decreasing thickness from the first central portion 125c to the first end portion 125a or the second end portion 125b. Accordingly, the first central portion 125c may be formed to have a greater thickness than a thickness of the first end portion 125a or the second end portion 125b.

The first conductive resin layer 125 may be preferably disposed on a portion of at least one surface of the third surface S3, the fourth surface S4, the fifth surface S5, and the sixth surface S6, which are the thickness directional or width directional end surfaces of the ceramic body 110, but not disposed on an outer surface of the first sintered electrode layer 123. In addition, the first conductive resin layer 125 may not be disposed on an outer surface in the first direction, i.e., the outer surface in the longitudinal direction, of the ceramic body 110 among outer surfaces of the first sintered electrode layer 123.

Unlike the present embodiment, when the conductive resin layer is also disposed on the outer surface of the first sintered electrode layer, the problem of increasing the equivalent series resistance (ESR) of the first external electrode due to the conductive resin layer may occur. Furthermore, since a resin layer exists on the electrode layer, the external electrode may become thicker and the relative volume of the ceramic body may be small in comparison to the case where there exists only the electrode layer, such that there may be a problem of decreasing the effective capacity of the multilayer ceramic capacitor.

On the other hand, according to the present embodiment, the first metal electrode layer 121 and the first sintered electrode layer 123 in the form of a thin film may be disposed on the first surface S1 of the ceramic body 110, and the first conductive resin layer 125 may not be disposed on the outer surface in the first direction, i.e., the outer surface in the longitudinal direction, of the ceramic body 110 among outer surfaces of the first sintered electrode layer 123, which may not cause the problem described above.

The second external electrode 130 may include a second metal electrode layer 131, a second sintered electrode layer 133 and a second conductive resin layer 135.

The second metal electrode layer 131 may be disposed on the second surface S2 of the ceramic body 110, and may be a portion electrically connected to exposed end portions of the plurality of second internal electrodes 160.

The second sintered electrode layer 133 may be disposed on the second metal electrode layer 131, and an end portion of the second sintered electrode layer 133 may be disposed at a portion connecting the second surface S2 and at least one surface among the third surface S3, the fourth surface S4, the fifth surface S5, and the sixth surface S6 of the ceramic body 110. Hereinafter, for better comprehension and ease of description, the portion connecting the second surface S2 and at least one surface among the third surface S3, the fourth surface S4, the fifth surface S5, and the sixth surface S6 of the ceramic body 110 will be referred to the second edge portion C2.

The second conductive resin layer 135 may be disposed on a portion of at least one surface among the third surface S3, the fourth surface S4, the fifth surface S5, and the sixth surface S6 of the ceramic body 110, and may be in contact with the second sintered electrode layer 133 in the second edge portion C2.

The second external electrode 130 corresponds to the structure, material and function of the first external electrode 120, except for its position, and repeated description thereon will be omitted.

Meanwhile, the multilayer ceramic capacitor 100 may further include a first plating layer 180 and a second plating layer 190.

The first plating layer 180 may cover the first external electrode 120. The first plating layer 180 may include a first layer 181 and a second layer 183. The first layer 181 may cover the first sintered electrode layer 123 and the first conductive resin layer 125, and the second layer 183 may be disposed on the first layer 181. The first layer 181 may include nickel (Ni) and the second layer 183 may include tin (Sn), but the present embodiment is not limited thereto.

The second plating layer 190 may cover the second external electrode 130. The second plating layer 190 may include a first layer 191 and a second layer 193. The first layer 191 may cover the second sintered electrode layer 133 and the second conductive resin layer 135, and the second layer 193 may be disposed on the first layer 191. The first layer 191 may include nickel (Ni) and the second layer 193 may include tin (Sn), but the present embodiment is not limited thereto.

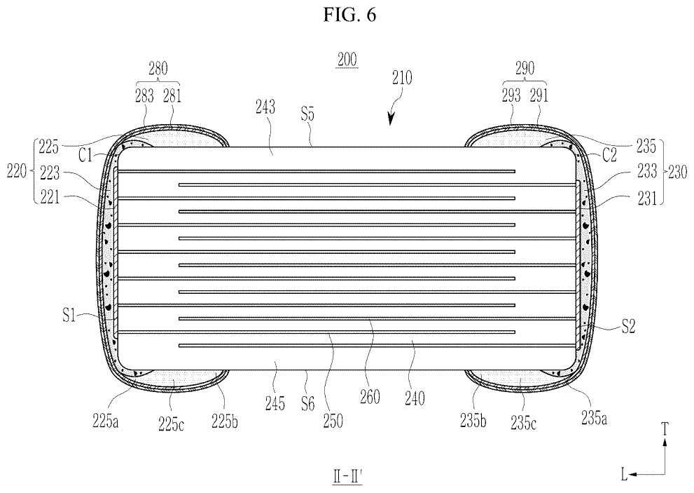

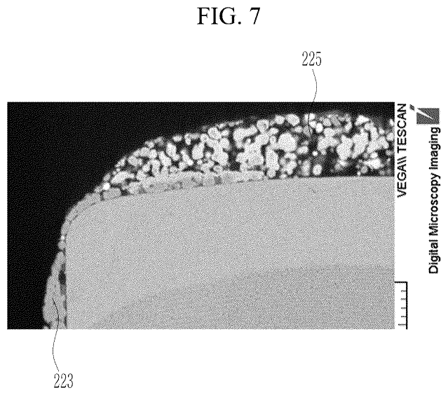

FIG. 6 is a cross-sectional view in the L-T direction of the multilayer ceramic capacitor according to another embodiment, and FIG. 7 is a digital image with respect to a portion of the multilayer ceramic capacitor according to another embodiment.

Referring to FIG. 6, a multilayer ceramic capacitor 200 may include a ceramic body 210, a first external electrode 220, a second external electrode 230, a plurality of first internal electrodes 250, and a plurality of second internal electrodes 260. Components of the multilayer ceramic capacitor 200 except for the structure of the first external electrode 220 and the second external electrode 230 are the same as or correspond to the components of the multilayer ceramic capacitor 100 of FIG. 1 to FIG. 4, and repeated description thereon will be omitted.

The first external electrode 220 may be disposed on the first surface S1 of the ceramic body 210, and may extend to a portion of at least one surface of the third surface S3, the fourth surface S4, the fifth surface S5, and the sixth surface S6. The second external electrode 230 may be disposed on the second surface S2 of the ceramic body 210, and may extend to a portion of at least one surface of the third surface S3, the fourth surface S4, the fifth surface S5, and the sixth surface S6.

The first external electrode 220 may include a first metal electrode layer 221, a first sintered electrode layer 223, and a first conductive resin layer 225.

The first metal electrode layer 221 may be disposed on the first surface S1 of the ceramic body 210, and may be a portion electrically connected to exposed end portions of the plurality of first internal electrodes 250.

The first sintered electrode layer 223 may be disposed on the first metal electrode layer 221, and may be disposed onto a portion of at least one surface of the third surface S3, the fourth surface S4, the fifth surface S5, and the sixth surface S6, which are the thickness directional or width directional end surfaces of the ceramic body 210. Accordingly, an end portion of the first sintered electrode layer 223 may cover a portion of at least one surface among the third surface S3, the fourth surface S4, the fifth surface S5, and the sixth surface S6 of the ceramic body 210. In this way, hermetic sealing of the external electrode can be further secured.

The first conductive resin layer 225 may be disposed on a portion of at least one surface of the third surface S3, the fourth surface S4, the fifth surface S5, and the sixth surface S6, which are the thickness directional or width directional end surface of the ceramic body 210, and may be in contact with the first sintered electrode layer 223 between the first surface S1 and at least one surface of these surfaces. In this embodiment, since at least one end portion of the first sintered electrode layer 223 is disposed onto a portion of at least one surface among the third surface S3, the fourth surface S4, the fifth surface S5, and the sixth surface S6 of the ceramic body 210, the first conductive resin layer 225 may cover the end portion of the first sintered electrode layer 223.

Referring to FIG. 7, in this embodiment, it may be seen that the first sintered electrode layer 223 is disposed onto a portion of the fifth surface S5 of the ceramic body 210, and the first conductive resin layer 225 covers the end portion of the first sintered electrode layer 223.

The second external electrode 230 may include a second metal electrode layer 231, a second sintered electrode layer 233, and a second conductive resin layer 235.

The second metal electrode layer 231 may be disposed on the second surface S2 of the ceramic body 210, and may be a portion electrically connected to exposed end portions of the plurality of second internal electrodes 260.

The second sintered electrode layer 233 may be disposed on the second metal electrode layer 231, and may be disposed onto a portion of at least one surface of the third surface S3, the fourth surface S4, the fifth surface S5, and the sixth surface S6, which are the thickness directional or width directional end surface of the ceramic body 210.

The second conductive resin layer 235 may be disposed on a portion of at least one surface of the third surface S3, the fourth surface S4, the fifth surface S5, and the sixth surface S6, which are the thickness directional or width directional end surface of the ceramic body 210, and may be in contact with the second sintered electrode layer 233 between the second surface S2 and at least one surface of these surfaces.

The second external electrode 230 corresponds to the structure, material and function of the first external electrode 220, except for its position, and repeated description thereon will be omitted.

Meanwhile, the multilayer ceramic capacitor 200 may further include a first plating layer 280 and a second plating layer 290.

The first plating layer 280 may cover the first external electrode 220. The first plating layer 280 may include a first layer 281 and a second layer 283. The first layer 281 may cover the first sintered electrode layer 223 and the first conductive resin layer 225, and the second layer 283 may be disposed on the first layer 281. The first layer 281 may include nickel (Ni) and the second layer 283 may include tin (Sn), but the present embodiment is not limited thereto.

The second plating layer 290 may cover the second external electrode 230. The second plating layer 290 may include a first layer 291 and a second layer 293. The first layer 291 may cover the second sintered electrode layer 233 and the second conductive resin layer 235, and the second layer 293 may be disposed on the first layer 291. The first layer 291 may include nickel (Ni) and the second layer 293 may include tin (Sn), but the present embodiment is not limited thereto.

### Experimental Example

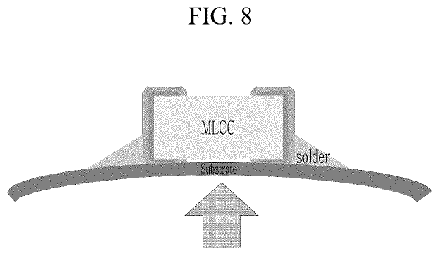

Hereinafter, bending characteristics and equivalent series resistance (ESR) of Example and Comparative Examples 1, 2, and 3 will be discussed with reference to FIG. 8 and Table 1.

FIG. 8 is a drawing for explaining the bending test method of the multilayer ceramic capacitor, and Table 1 is a table representing the bending characteristics and the equivalent series resistance (ESR) of Example and Comparative Examples 1, 2, and 3.

TABLE 1

| | Bending crack | |
|---|---|---|
| Classification | frequency (6 mm) | ESR [mΩ] |
| Example | 0% | 2.51 |
| Comparative Example 1 | 43% | 2.76 |
| Comparative Example 2 | 0% | 2.78 |
| Comparative Example 3 | 0% | 3.31 |

In Table 1, the Example was a multilayer ceramic capacitor in which the external electrode disposed outside the ceramic body included the structure shown in FIG. 1 to FIG. 4.

Comparative Example 1 was a multilayer ceramic capacitor in which the external electrode included only a sintered electrode layer.

Comparative Example 2 was a multilayer ceramic capacitor having an external electrode in which a sintered electrode layer is disposed on the first surface and the second surface of the ceramic body, and the conductive resin layer is disposed on the third surface to the sixth surface.

Comparative Example 3 was a multilayer ceramic capacitor having an external electrode in which a sintered electrode layer is disposed on the first surface and the second surface of the ceramic body, and the conductive resin layer is disposed on the sintered electrode layer and the third surface to the sixth surface.

Referring to FIG. 8, the multilayer ceramic capacitor (MLCC) was mounted on a substrate through soldering, which was then disposed on a device capable of pressing the mounting surface, an external bending force to cause bending of 6 mm was applied to an opposite surface of the mounting surface in the multilayer ceramic capacitor, and thereby whether a crack occurred was checked to measure the frequency of crack occurrence.

Referring to Table 1, in the case of Comparative Example 1 where the external electrode included only a sintered electrode layer, the bending crack frequency was very high at 43%, and in the case of Comparative Example 3 where a sintered electrode layer was disposed on the first surface and the second surface of the ceramic body, and the conductive resin layer was disposed on a sintered electrode layer and the third surface to the sixth surface, the bending crack frequency was 0%, but the equivalent series resistance (ESR) was very high at 3.31.

In the case of Comparative Example 2 where a sintered electrode layer was disposed on the first surface and the second surface of the ceramic body, and the conductive resin layer was disposed on the third surface to the sixth surface, the bending crack frequency was 0%, and the equivalent series resistance (ESR) was 2.78.

However, in the case of the Example where a metal electrode layer was disposed on the first surface and the second surface of the ceramic body, a sintered electrode layer was disposed on the metal electrode layer, and the conductive resin layer was disposed on a portion of the third surface to the sixth surface, the bending crack frequency was 0%, and the equivalent series resistance (ESR) was 2.51, which confirmed that the equivalent series resistance (ESR) was reduced in comparison to Comparative Example 2.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising:
a ceramic body comprising a plurality of dielectric layers, and a plurality of internal electrodes disposed such that at least one internal electrode among the plurality of internal electrodes interpose the plurality of dielectric layers; and
an external electrode disposed outside the ceramic body,
wherein the ceramic body comprises a first surface and a second surface facing each other in a first direction, a third surface and a fourth surface facing each other in a second direction and connecting the first surface and the second surface, a fifth surface and a sixth surface facing each other in a third direction and connecting the first surface and the second surface,
wherein the external electrode comprises:
a metal electrode layer disposed on the first surface and the second surface of the ceramic body, the metal electrode layer connecting to the plurality of internal electrodes;
a sintered electrode layer disposed on the metal electrode layer, the sintered electrode layer comprising metal and glass; and
a conductive resin layer disposed on a portion of at least one surface among the third surface to the sixth surface of the ceramic body,
wherein the conductive resin layer is in contact with the sintered electrode layer in a portion connecting the first surface and the second surface of the ceramic body to at least one surface among the third surface to the sixth surface.

2. The multilayer ceramic capacitor of claim 1, wherein at least one end portion of the sintered electrode layer is disposed in the portion connecting the first surface and the second surface of the ceramic body to at least one surface among the third surface to the sixth surface.

3. The multilayer ceramic capacitor of claim 1, wherein at least one end portion of the sintered electrode layer is disposed onto a portion of at least one surface among the third surface to the sixth surface of the ceramic body.

4. The multilayer ceramic capacitor of claim 1, wherein a first end of the conductive resin layer is in contact with the at least one end portion of the sintered electrode layer.

5. The multilayer ceramic capacitor of claim 1, wherein a first end of the conductive resin layer covers the at least one end portion of the sintered electrode layer.

6. The multilayer ceramic capacitor of claim 1, wherein the conductive resin layer is not disposed on an outer surface disposed in the first direction among outer surfaces of the sintered electrode layer.

7. The multilayer ceramic capacitor of claim 1, wherein the sintered electrode layer covers the metal electrode layer.

8. The multilayer ceramic capacitor of claim 1, wherein the sintered electrode layer has a thickness decreasing toward an end portion of the sintered electrode layer.

9. The multilayer ceramic capacitor of claim 1, wherein the conductive resin layer comprises a first end portion in contact with the sintered electrode layer, and a second end portion facing the first end portion in the first direction.

10. The multilayer ceramic capacitor of claim 9, wherein the first end portion of the conductive resin layer covers at least one end portion of the sintered electrode layer.

11. The multilayer ceramic capacitor of claim 1, wherein the metal electrode layer comprises copper (Cu) or nickel (Ni).

12. The multilayer ceramic capacitor of claim 1, wherein the metal electrode layer has a thickness of 0.5 μm or more and 3 μm or less in the first direction.

13. The multilayer ceramic capacitor of claim 1, wherein the conductive resin layer comprises a conductive metal and epoxy.

14. The multilayer ceramic capacitor of claim 1, further comprising a plating layer covering the external electrode.

15. A multilayer ceramic capacitor, comprising:
a ceramic body comprising a plurality of dielectric layers, and a plurality of internal electrodes disposed such that at least one internal electrode among the plurality of internal electrodes interpose the plurality of dielectric layers;
an external electrode disposed outside the ceramic body,
wherein the ceramic body comprises a first surface and a second surface facing each other in a first direction, a third surface and a fourth surface facing each other in a second direction and connecting the first surface and the second surface, and a fifth surface and a sixth surface facing each other in a third direction and connecting the first surface and the second surface,
wherein the external electrode comprises:
a metal electrode layer disposed on the first surface and the second surface of the ceramic body, the metal electrode layer connecting to the internal electrode;
a sintered electrode layer disposed on the metal electrode layer, the sintered electrode layer comprising metal and glass; and
a conductive resin layer disposed on a portion of at least one surface among the third surface to the sixth surface of the ceramic body, the conductive resin layer connecting to the sintered electrode layer,
wherein the conductive resin layer is not disposed on an outer surface disposed in the first direction among outer surfaces of the sintered electrode layer.

16. The multilayer ceramic capacitor of claim 15, wherein the conductive resin layer comprises a first end portion in contact with the sintered electrode layer, and a second end portion facing the first end portion in the first direction.

17. The multilayer ceramic capacitor of claim 16, wherein the first end portion of the conductive resin layer covers at least one end portion of the sintered electrode layer.

18. A multilayer ceramic capacitor, comprising:
a ceramic body comprising a plurality of dielectric layers, and a plurality of internal electrodes disposed such that at least one internal electrode among the plurality of internal electrodes interpose the plurality of dielectric layers; and
an external electrode disposed outside the ceramic body, the external electrode comprising:
a first electrode layer disposed on opposing surfaces of the ceramic body, the first electrode layer connecting to the plurality of internal electrodes, and the first electrode layer including a metal;
a second electrode layer including a first portion disposed on the first electrode layer, and a second portion disposed on corners of the ceramic body, the second electrode layer comprising metal and glass; and
a conductive resin layer disposed on the corners of the ceramic body such that, along a stacking direction of the plurality of internal electrodes, the conductive resin layer overlaps the second portion of the second electrode layer and not the first portion of the electrode layer.

19. The multilayer ceramic capacitor of claim 18, wherein the first electrode layer is free of glass.

20. The multilayer ceramic capacitor of claim 18, wherein the second electrode layer covers the first electrode layer.

21. The multilayer ceramic capacitor of claim 18, wherein the second electrode layer has a thickness decreasing toward an end portion of the second electrode layer.
